(19) United States
(12) Patent Application Publication
(10) Pub. No.: US 2009/0190483 A1
(43) Pub. Date: Jul. 30, 2009

(54) Network transmission system and a testing method thereof

(75) Inventor: Yu-Chang Chang, Taipei City (TW)

Correspondence Address: Chih Feng Yeh;BRIAN M. MCINNIS, 12th Floor, Ruttonjee House, 11 Duddell Street, Hong Kong, HK

(73) Assignee: Inventec Corporation

(21) Appl. No.: 12/010,534

(22) Filed: Jan. 25, 2008

(51) Int. Cl. H04L 29/06

(52) U.S. Cl. 370/252

(57) ABSTRACT

A method, testing the network transmission, includes the step of providing a buffer of a scheduled size in a first storage unit, moving at least one transmission data from a second storage unit to the buffer in the first storage unit, and uploading the transmission data from the buffer in the first storage unit to an Internet.

### BACKGROUND

1. Field of Invention

The present invention relates to a network transmission system and a testing method thereof. More particularly, the present invention relates to a FTP network transmission system and a testing method thereof.

2. Description of Related Art

The file transfer protocol (FTP) is a long-term, well-established file transferring protocol. Similar to most network protocol, the FTP adapts client/server architecture, and the clients are able to link to the server through the network to upload or download files. In particular, the FTP needs to establish two links: one link transmits the instructions, and the other link transfers files.

When the client links to the server with the FTP software, the client links to the ports of the server and establishes a Control Stream in first. Next, the client needs to enter an account, a password as well as other instructions, in which the account, the password, as well as other instructions and the responses thereof are transmitted with the control stream. When the client needs to download files or a file directory, the files or file directory are transmitted with the Data Stream. The difference between the Control Stream and the Data Stream is that the Data Stream transfers more data than the Control Stream, in which the Control Stream transfer merely the instructions and the responses thereof.

However, the conventional FTP test tools can't adjust the transmission speed during the testing procedure, which fails to test the maximum bandwidth of the Internet. In other words, the conventional test tool can test only the function of the FTP, not the transmission speed of the FTP.

Therefore, there is a need for a new transmission system and the testing methods thereof, which can tune the transmission speed accordingly and test both the function and the speed of the network system.

### SUMMARY

According to one embodiment of the present invention, a method for testing the network transmission is disclosed. The method includes providing a buffer of a scheduled size in a first storage unit, moving at least one transmission data from a second storage unit to the buffer in the first storage unit, and uploading the transmission data from the buffer in the first storage unit to an Internet.

According to another embodiment of the present invention, a network transmission system includes a first storage device, a second storage device, a transmission module, and a network transmission interface. The size of the first storage unit corresponds to the speed of Internet. The second storage device stores at least one transmission data. The transmission module transmits the transmission data from the second storage device to the first storage device. The network transmission interface transmits the transmission data from the first storage device to the Internet.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows the network transmission system according to one embodiment of the present invention; and

FIG. 2 shows the flow chart of the network transmission testing method according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The network transmission system and the testing method of the following embodiments tunes the buffer size according to the transmission speed, and transmits transmission data from the buffer to the Internet to test the network function and the efficiency.

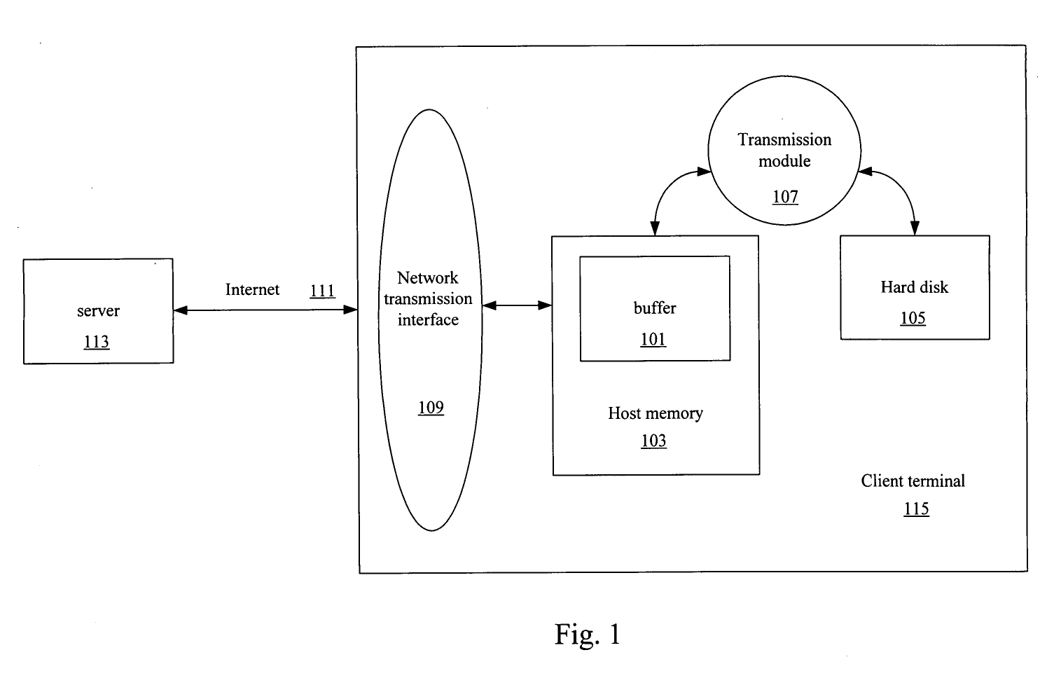

FIG. 1 shows the network transmission system according to one embodiment of the present invention. The network transmission system includes the server 113, the Internet 111 and the client terminal 115. The client terminal 115 can upload/download the transmission data to/from the server 113 through the Internet 111 with the FTP type packets.

For example, the files or the file directory stored on the hard disk 105 can be transmitted to the server 113 with the FTP link; the client terminal 115 can also edit or delete the files stored on the server 113, and can even upload/download the whole directory with the FTP link. Because the FTP link is not forced to be disconnected even if the FTP link is idle for a period of time, and the FTP link can hold the connection all the time, therefore, the local file directory and the remote file directory can be synchronized with the FTP link.

The client terminal 115 includes the first storage unit, the second storage unit, the transmission module 107, and the network transmission interface 109. The client terminal 115 provides the buffer 101 of the host memory 103 to be the first storage unit. The size of the buffer 101 corresponds to the speed of the Internet, and can be tuned by the network testing module accordingly. For example, if the Internet bandwidth is 100 M bits, then the buffer size can be tuned to 12.5 M byte (1 byte=8 bits) accordingly in order to the make Internet fully-loaded and speed up the transmission rate.

The second storage unit of the client terminal 115, such as the hard disk 105, stores the transmission data. The transmission data stored on the hard disk 105 can be transmitted to the buffer 101 of the host memory 103 through the transmission module 107, such as the IDE interface. Because the access speed of the host memory 103 is greater than the access speed of the hard disk, the transmission data stored in the hard disk 105 can be moved/copied to the buffer 101 first, and transmitted from the buffer 101 next. Hence, the transmission data can be transmitted from the buffer 101 instead of the hard disk 105, and the hard disk accesses are no longer required, which speeds up the transmission rate and fully loads the Internet.

The network transmission interface 109, such as the network adapter, transmits the transmission data stored in the buffer 101 to the server 113 through the Internet 111 with the FTP packets.

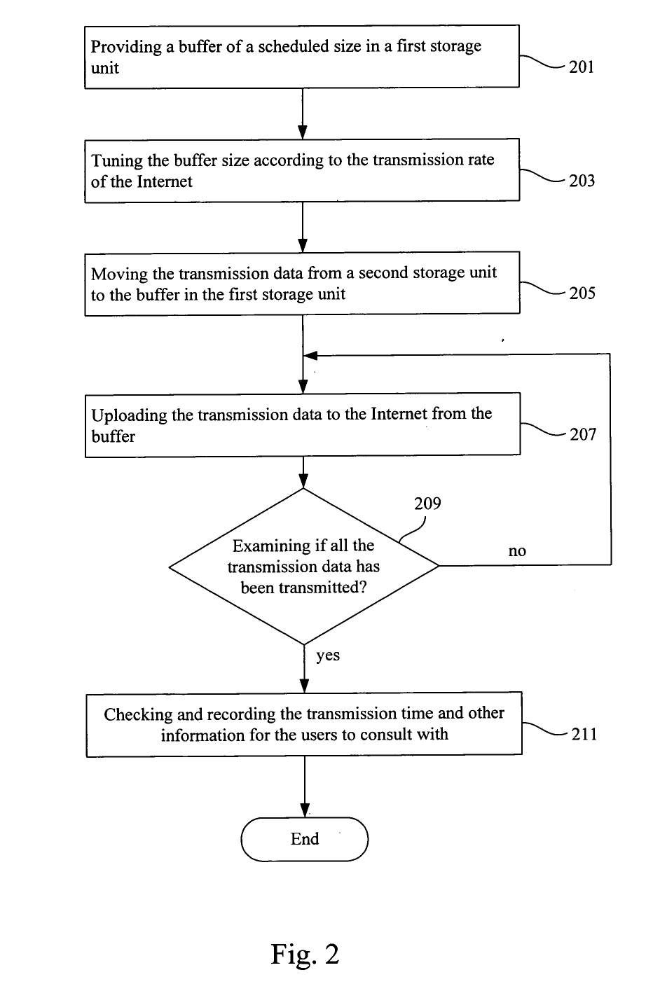

FIG. 2 shows the flow chart of the network transmission testing method according to one embodiment of the present invention. The network transmission testing method first provides a buffer of a scheduled size in a first storage unit (step 201). For example, a block of the host memory in the client terminal is separated as the buffer. Next, the buffer size is tuned according to the transmission rate of the Internet (step 203). The buffer size can be tuned equal to the bandwidth of the Internet, or tuned according to the required transmission rate. For example, if the Internet bandwidth is 100 M bits, but the required transmission rate is half of the bandwidth, then the buffer size can be tuned to 6.25 M bytes (100 M divided by 2×8).

After the buffer size is determined, the transmission data is moved from a second storage unit to the buffer in the first storage unit (step 205), in which the second storage unit may be the hard disk for storing the transmission data. Then, the transmission data is uploaded to the Internet from the buffer (step 207), and also uploaded to the server through the Internet, in which the transmission data can be transmitted with the FTP packets.

After step 207, the buffer is examined to check if all the transmission data has been transmitted (step 209). If there is un-transmitted transmission data in the buffer, step 207 is performed again to transmit the transmission data; on the contrary, if all the transmission data has been transmitted, the correction of the transmission, the transmission time and other information is checked and recorded for the users to consult with (step 211).

The user can identify the network transmission security according to the record. The user can also analyze the efficiency of the network adapter by identifying the compatibility between the network adapter and the operating system according to the record. The user can further debug the transmission system according to the testing record.

According to the above embodiment, network transmission system and the testing method thereof move the transmission data from the second storage unit from to the buffer in the first storage unit, then upload data from the buffer to the Internet. As the access speed of the first storage unit is faster than the second storage unit, and the transmission data can be uploaded directly from the buffer in the first storage unit, the second storage unit access is no longer required, which accelerates the data transmission rate. In addition, the buffer size can be tuned according to the transmission speed, which makes the fully loads the Internet in order to test the network transmission efficiency and the functionality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for testing the network transmission, comprising:
providing a buffer of a scheduled size in a first storage unit;
moving at least one transmission data from a second storage unit to the buffer in the first storage unit; and
uploading the transmission data from the buffer in the first storage unit to an Internet.

2. The method of claim 1, wherein the first storage unit and the second storage unit are a host memory and a hard disk in a client terminal respectively, and the transmission data in the buffer of the host memory is transmitted to a server through the Internet.

3. The method of claim 1, further comprising tuning the size of the buffer according to the speed of the Internet.

4. The method of claim 1, further comprising tuning the size of the buffer according to the bandwidth of the Internet.

5. The method of claim 4, wherein the size of the buffer is one eighth of the bandwidth of the Internet.

6. The method of claim 1, wherein the transmission data stored in the buffer of the first storage unit is transmitted to the server through the Internet with the File Transfer Protocol.

7. A network transmission system, comprising:
a first storage device, wherein the size of the first storage device corresponds to the speed of Internet;
a second storage device for storing at least one transmission data;
a transmission module for transmitting the transmission data form the second storage device to the first storage device; and
a network transmission interface for transmitting the transmission data from the first storage device to the Internet.

8. The network transmission system of claim 7, wherein the first storage device is a buffer of a host memory in a client terminal, and the second storage device is the hard disk in the client terminal.

9. The network transmission system of claim 7, wherein the network transmission interface is a network adapter, and the transmission data is transmitted to a server through the Internet with the File Transfer Protocol by the network adapter.
